(19) United States
(12) Patent Application Publication
(10) Pub. No.: US 2025/0054683 A1
(43) Pub. Date: Feb. 13, 2025

(54) COIL COMPONENT

(71) Applicant: Murata Manufacturing Co., Ltd., Kyoto-fu (JP)

(72) Inventors: Yuki KANBE, Nagaokakyo-shi (JP); Hayato TAKAHASHI, Nagaokakyo-shi (JP); Shingo NAKAMOTO, Nagaokakyo-shi (JP); Seiji KARIMORI, Nagaokakyo-shi (JP); Masayuki ISHIDA, Nagaokakyo-shi (JP)

(73) Assignee: Murata Manufacturing Co., Ltd., Kyoto-fu (JP)

(21) Appl. No.: 18/796,110

(22) Filed: Aug. 6, 2024

(30) Foreign Application Priority Data
Aug. 10, 2023 (JP) 2023-131423

(51) Int. Cl. H01F 27/28; H01F 27/24; H01F 27/29; H01F 27/30

(52) U.S. Cl. CPC H01F 27/2823; H01F 27/24; H01F 27/292; H01F 27/306

(57) ABSTRACT

A coil component includes a drum core including a core portion and first and second flange portions; first, second, third and fourth outer electrodes; and first and second wires. The second wire includes first and second winding portions. The first winding portion is a portion including plural turns wound around an outer periphery of the first wire. The second winding portion is on a second wire end side relative to the first winding portion and includes less than 1.0 turn continuously wound around the outer periphery of the first wire. The first winding portion includes a first traverse portion, which runs across the first wire without running in the same layer as the first wire in one turn immediately preceding an end portion of the first winding portion where the end portion is the closest to the second wire end in the first winding portion.

### CROSS-REFERENCE TO RELATED APPLICATION

This application claims benefit of priority to Japanese Patent Application No. 2023-131423, filed Aug. 10, 2023, the entire content of which is incorporated herein by reference.

### BACKGROUND

### Technical Field

The present disclosure relates to a coil component.

### Background Art

A coil component described in Japanese Unexamined Patent Application Publication No. 2016-195290 includes a core, four outer electrodes, a first wire, and a second wire. The core includes a core portion, a first flange portion, and a second flange portion. The core portion has a rectangular prism shape. The first flange portion is coupled to a first end of the core portion. The second flange portion is coupled to a second end of the core portion. Two of the four outer electrodes are positioned on the surface of the first flange portion. The other two outer electrodes are positioned on the surface of the second flange portion.

The first wire is wound around the core portion. A first end of the first wire is coupled to one of the outer electrodes on the first flange portion. A second end of the first wire is coupled to one of the outer electrodes on the second flange portion. The second wire is wound around the core portion. A first end of the second wire is coupled to the other outer electrode on the first flange portion. A second end of the second wire is coupled to the other outer electrode on the second flange portion. The second wire is wound in the same direction as the first wire.

### SUMMARY

Coil components like described in Japanese Unexamined Patent Application Publication No. 2016-195290 could change in electric and magnetic characteristics depending on the direction of current flowing through each wire. In order to obtain expected characteristics of the coil component, the coil component needs to be mounted on a substate in a predetermined orientation. For example, the orientation of the coil component may be distinguished with an optically-observable mark provided on the core of the coil component. In this case, it is necessary to perform an additional step only for providing such a mark in the manufacturing process, so that the manufacturing process will be inevitably complicated.

Accordingly, the present disclosure provides a coil component including a drum core including: a columnar core portion; a first flange portion coupled to a first end of the core portion in a direction along a central axis; and a second flange portion coupled to a second end of the core portion on a side opposite to the first end; a first outer electrode and a second outer electrode that are positioned on a surface of the first flange portion; a third outer electrode and a fourth outer electrode that are positioned on a surface of the second flange portion; a first wire that is wound around the core portion and has a first wire end coupled to the first outer electrode and a second wire end coupled to the third outer electrode; and a second wire that is wound around the core portion in the same direction as the first wire and has a first wire end coupled to the second outer electrode and a second wire end coupled to the fourth outer electrode. The number of turns of the first wire increases by one from the first wire end toward the second wire end each time the first wire turns once around the central axis. Also, the number of turns of the second wire increases by one from the first wire end toward the second wire end each time the second wire turns once around the central axis. The second wire includes a first winding portion including a plurality of turns wound around an outer periphery of the first wire; and a second winding portion which is positioned on a second wire end side relative to the first winding portion, at least a part of which is wound around an outer surface of the core portion, and which includes less than 1.0 turn continuously wound around the outer periphery of the first wire. Also, the first winding portion includes a first traverse portion that runs across the first wire without running in the same layer as the first wire in one turn immediately preceding an end portion of the first winding portion, where the end portion of the first winding portion refers to a portion of the second wire closest to the second wire end in the first winding portion when the second wire is traced from the first wire end toward the second wire end in the first winding portion.

The orientation of the coil component can be distinguished without a mark being attached on the core.

### BRIEF DESCRIPTION OF THE DRAWINGS

FIG. 1 is a perspective view of a coil component;

FIG. 2 is a plan view of the coil component;

FIG. 3 is a diagram explaining a winding manner of wires when the coil component is viewed in a third negative direction;

FIG. 4 is a diagram explaining the winding manner of wires when the coil component is viewed in a second positive direction; and

FIG. 5 is a diagram explaining a winding manner of wires when a coil component of a modification is viewed in the second positive direction.

### DETAILED DESCRIPTION

### Overall Configuration

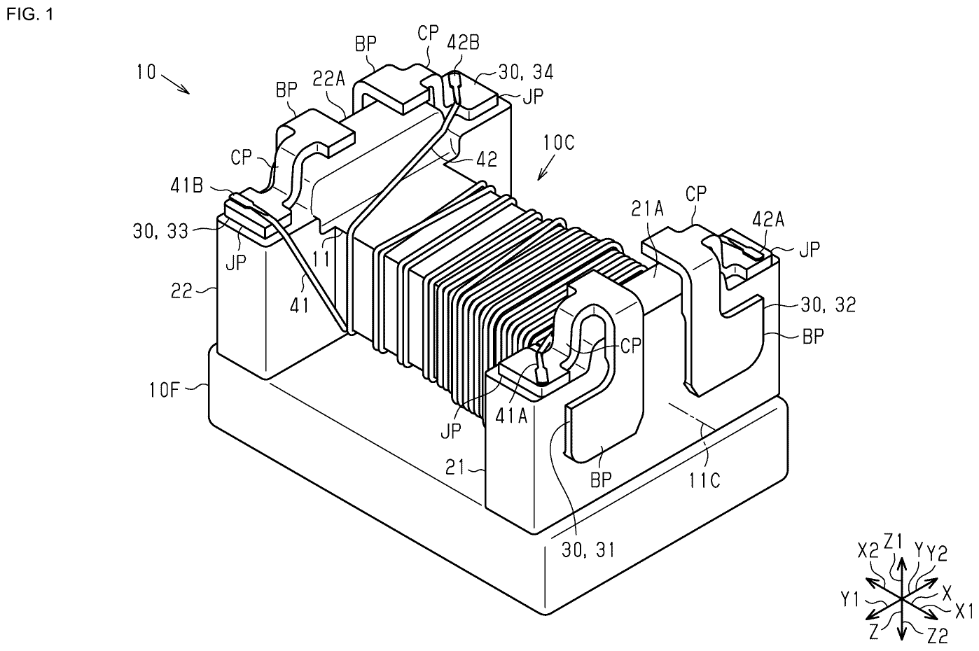

As illustrated in FIG. 1, a coil component 10 includes a drum core 10C and a top plate 10F.

The drum core 10C includes a core portion 11, a first flange portion 21, and a second flange portion 22. The core portion 11 has a rectangular prism shape. The cross-section of the core portion 11 perpendicular to a central axis 11C has a rectangular shape. The “rectangular shape” herein needs to have four sides and generally form a rectangle, including a rectangle with chamfered corners. The core portion 11 is made of Ni—Zn ferrite in the embodiment. Examples of the material of the core portion 11 can include alumina, Ni—Zn ferrite, synthetic resin, and mixtures thereof.

Herein, a particular axis parallel to the central axis 11C of the core portion 11 is referred to as a first axis X. An axis perpendicular to the first axis X is referred to as a second axis Y. In the embodiment, the second axis Y is parallel to two of the four sides of the core portion 11 when viewed along the first axis X. An axis perpendicular to both the first axis X and the second axis Y is referred to as a third axis Z. In the embodiment, the third axis Z is parallel to the other two of the four sides of the core portion 11 when viewed along the first axis X. One of the directions along the first axis X is referred to as a first positive direction X1, and the direction opposite to the first positive direction X1 is referred to as a first negative direction X2. In a similar manner, one of the directions along the second axis Y is referred to as a second positive direction Y1, and the direction opposite to the second positive direction Y1 is referred to as a second negative direction Y2. One of the directions along the third axis Z is referred to as a third positive direction Z1, and the direction opposite to the third positive direction Z1 is referred to as a third negative direction Z2. In the embodiment, a particular direction perpendicular to the central axis 11C corresponds to the third positive direction Z1.

As illustrated in FIG. 1, the first flange portion 21 is coupled to a first end of the core portion 11 on its first positive direction X1 side. The first flange portion 21 with the core portion 11 constitutes a single-piece object. The first flange portion 21 is therefore made of the same Ni—Zn ferrite as the core portion 11.

The first flange portion 21 protrudes outside from the core portion 11 along the second axis Y and along the third axis Z. In the first flange portion 21, a portion 21 A at the center along the second axis Y protrudes in the third positive direction Z1 relative to both ends along the second axis Y. In other words, the end portion of the first flange portion 21 on its second positive direction Y1 side and the end portion of the first flange portion 21 on its second negative direction Y2 side are recessed in the third negative direction Z2 relative to the portion 21A at the center along the second axis Y.

The second flange portion 22 is coupled to a second end of the core portion 11 on its first negative direction X2 side. The second flange portion 22 with the core portion 11 constitutes a single-piece object. The second flange portion 22 is made of the same Ni—Zn ferrite as the core portion 11.

The second flange portion 22 protrudes from the core portion 11 along the second axis Y and along the third axis Z. In the second flange portion 22, a portion 22A at the center along the second axis Y protrudes in the third positive direction Z1 with respect to both ends along the second axis Y. In other words, the end portion of the second flange portion 22 on its second positive direction Y1 side and the end portion of the second flange portion 22 on its second negative direction Y2 side are recessed in the third negative direction Z2 relative to the portion 22A at the center along the second axis Y.

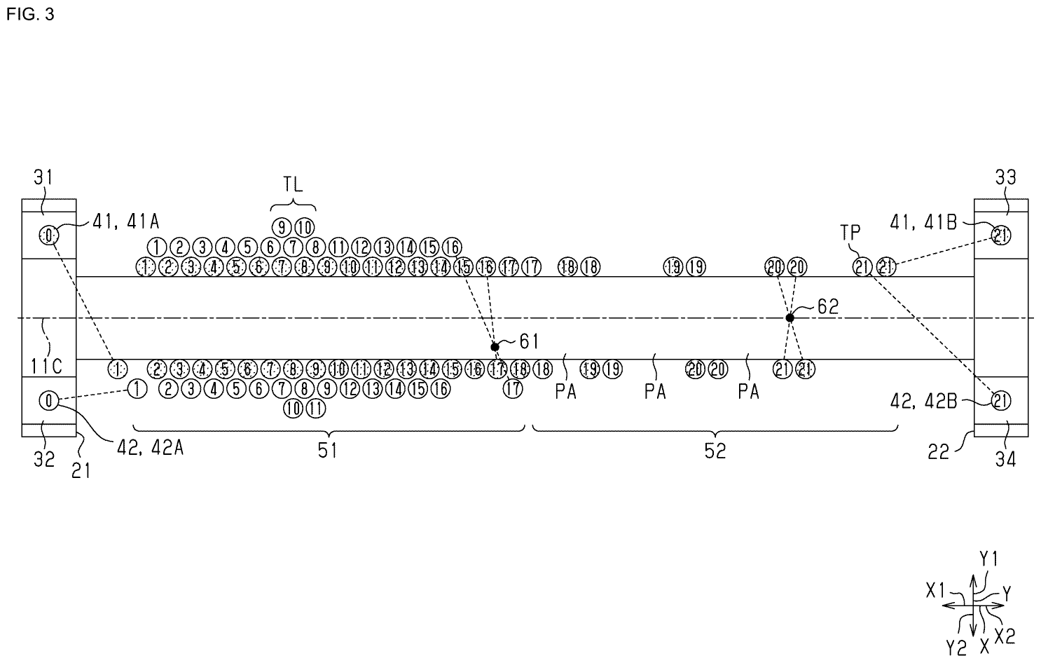

The top plate 10F has a rectangular plate-like shape. The dimension of the top plate 10F along the third axis Z is small compared to its dimension along the first axis X and its dimension along the second axis Y. The long sides of the top plate 10F are parallel to the first axis X. The short sides of the top plate 10F are parallel to the second axis Y. The top plate 10F is positioned on the third negative direction Z2 side relative to the drum core 10C. The top plate 10F is coupled to both the surface of the first flange portion 21 facing the third negative direction Z2 and the surface of the second flange portion 22 facing the third negative direction Z2. The top plate 10F is thus laid across the first flange portion 21 and the second flange portion 22. The top plate 10F is made of the same Ni-Zn ferrite as the drum core 10C. In FIGS. 3 to 5, illustration of the top plate 10F is omitted.

The coil component 10 includes four outer electrodes 30. The four outer electrodes 30 are a first outer electrode 31, a second outer electrode 32, a third outer electrode 33, and a fourth outer electrode 34. The first outer electrode 31 is attached to the first flange portion 21. On the surface of the first flange portion 21, the first outer electrode 31 is positioned on the second positive direction Y1 side relative to the center of the first flange portion 21 along the second axis Y. Most of the first outer electrode 31 is positioned on the third positive direction Z1 side relative to the core portion 11.

The first outer electrode 31 includes a bonding portion BP, a connecting portion CP, and a joining portion JP. The bonding portion BP, connecting portion CP, and joining portion JP constitute a single-piece object. That is, there are no clear boundaries between these members in the first outer electrode 31.

The bonding portion BP has a substantially plate-like shape. The bonding portion BP has a substantially L shape when viewed BP along the second axis Y. This means that the bonding portion BP includes a face perpendicular to the first axis X and a face perpendicular to the third axis Z. A part of the face of the bonding portion BP perpendicular to the first axis X is bonded to the surface of the first flange portion 21 facing the first positive direction X1.

The connecting portion CP has a substantially plate-like shape. The connecting portion CP is coupled to the end face of the bonding portion BP on the second positive direction Y1 side. The connecting portion CP extends in the third negative direction Z2 while extending in the second positive direction Y1. The connecting portion CP has a substantially L shape when viewed along the first axis X. That is, the connecting portion CP has a face perpendicular to the second axis Y and a face perpendicular to the third axis Z.

The joining portion JP has a substantially plate-like shape. The joining portion JP is coupled to the end face of the connecting portion CP on the second positive direction Y1 side. The joining portion JP is positioned on the surface of the first flange portion 21 facing the third positive direction Z1. That is, the joining portion JP is positioned on the surface of the first flange portion 21 on the third positive direction Z1 side relative to the central axis 11C. To the surface of the joining portion JP facing the third positive direction Z1, an end of a later-described wire is coupled. When the joining portion JP to which the wire end is coupled is positioned on the surface of the first flange portion 21 on the third positive direction Z1 side relative to the central axis 11C in such a manner, the first outer electrode 31 is considered to be positioned on the surface of the first flange portion 21 on the third positive direction Z1 side relative to the central axis 11C.

The second outer electrode 32 is attached to the first flange portion 21. On the surface of the first flange portion 21, the second outer electrode 32 is positioned on the second negative direction Y2 side relative to the center of the first flange portion 21 along the second axis Y. Most of the second outer electrode 32 is positioned on the third positive direction Z1 side relative to the core portion 11. The shape of the second outer electrode 32 is symmetric to that of the first outer electrode 31. Specifically, the second and first outer electrodes 32 and 31 are symmetric with respect to a virtual plane that passes through the central axis 11C and is perpendicular to the second axis Y. The second outer electrode 32 is therefore positioned on the surface of the first flange portion 21 on the third positive direction Z1 side relative to the central axis 11C.

The third outer electrode 33 is attached to the second flange portion 22. On the surface of the second flange portion 22, the third outer electrode 33 is positioned on the second positive direction Y1 side relative to the center of the second flange portion 22 along the second axis Y. Most of the third outer electrode 33 is positioned on the third positive direction Z1 side relative to the core portion 11. The shape of the third outer electrode 33 is symmetric to that of the first outer electrode 31. Specifically, the third and first outer electrodes 33 and 31 are symmetric with respect to a virtual plane that is perpendicular to the central axis 11C and passes through the center C of the core portion 11. The third outer electrode 33 is therefore positioned on the surface of the second flange portion 22 on the third positive direction Z1 side relative to the central axis 11C.

The fourth outer electrode 34 is attached to the second flange portion 22. On the surface of the second flange portion 22, the fourth outer electrode 34 is positioned on the second negative direction Y2 side relative to the center of the second flange portion 22 along the second axis Y. Most of the fourth outer electrode 34 is positioned on the third positive direction Z1 side relative to the core portion 11. The shape of the fourth outer electrode 34 is symmetric to that of the third outer electrode 33. Specifically, the fourth and third outer electrodes 34 and 33 are symmetric with respect to a virtual plane that passes through the central axis 11C and is perpendicular to the second axis Y. The fourth outer electrode 34 is therefore positioned on the surface of the second flange portion 22 on the third positive direction Z1 side relative to the central axis 11C.

In the embodiment, the maximum dimension of the coil component 10 along the first axis X is 3.2 mm. The maximum dimension of the coil component 10 along the second axis Y is 2.5 mm. The maximum dimension of the coil component 10 along the third axis Z is 2.3 mm.

### First Wire and Second Wire

As illustrated in FIG. 1, the coil component 10 includes a first wire 41 and a second wire 42. The first wire 41 and the second wire 42 are wound around the core portion 11. The first wire 41 includes a conductor and an insulation coating, which are not illustrated. The insulation coating covers the outer surface of the conductor. The first wire 41 has a substantially circular shape in a cross section perpendicular to the direction in which the first wire 41 extends.

The second wire 42 has the same configuration as the first wire 41. Specifically, the second wire 42 includes a conductor and an insulation coating. The first wire 41 is indicated with dots in FIGS. 3 to 5.

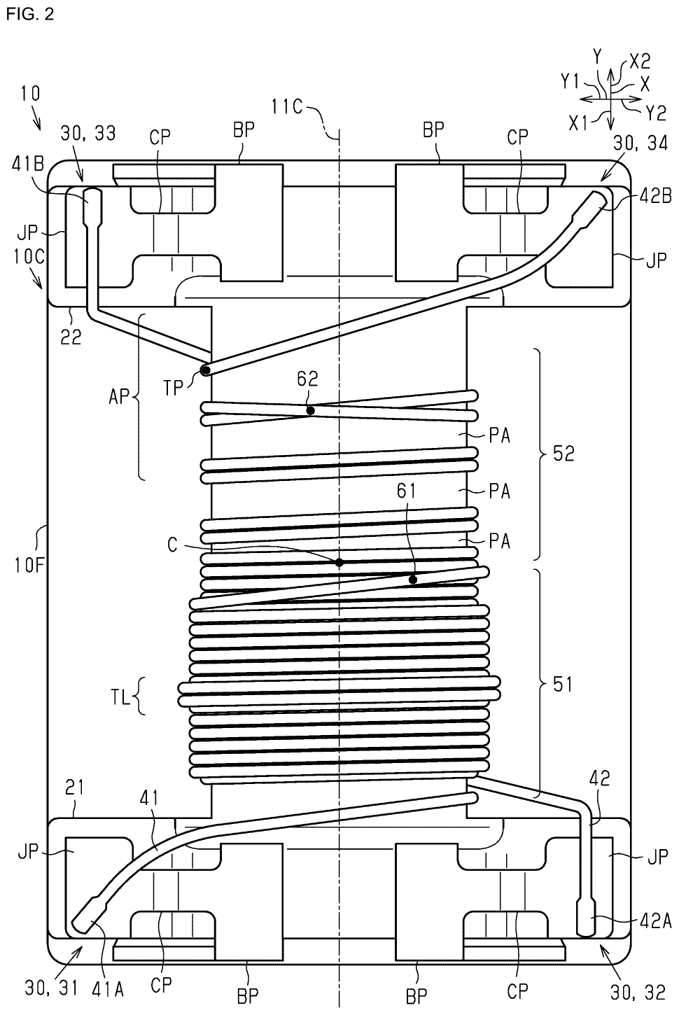

As illustrated in FIG. 2, a first wire end 41A of the first wire 41 is coupled to the first outer electrode 31. A second wire end 41B of the first wire 41 is coupled to the third outer electrode 33. The first wire end 41A and the second wire end 41B are each coupled to the joining portion JP of the corresponding outer electrode 30 by thermocompression bonding. Thermocompression bonding is a process of sandwiching a wire between the outer electrode 30 and a heated jig to melt the wire for fixing the wire to the outer electrode 30.

Herein, when the first wire 41 is traced from the first wire end 41A to the second wire end 41B, the first point that comes into contact with the outer surface of the core portion 11 is defined as a point of 1.0 turn of the first wire 41. In the embodiment, the point of 1.0 turn of the first wire 41 is positioned on the edge of the core portion 11 on its second negative direction Y2 side and on its third positive direction Z1 side.

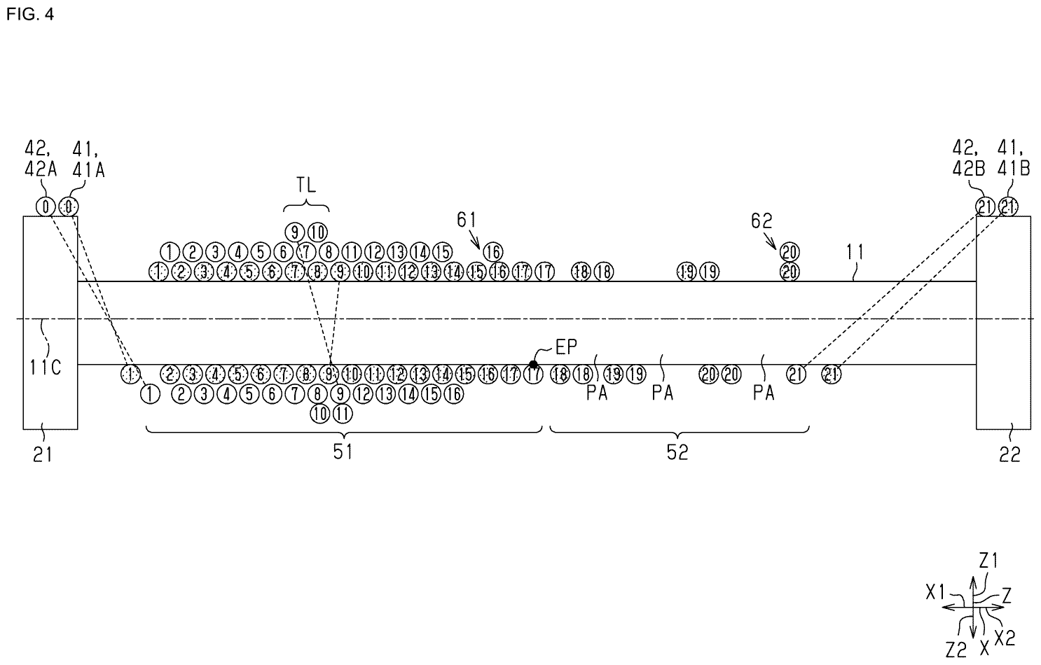

As illustrated in FIGS. 3 and 4, the number of turns of the first wire 41 increases from the first wire end 41A to the second wire end 41B by one each time the first wire 41 turns once around the central axis 11C. When viewed in the first negative direction X2, the first wire 41 is wound clockwise around the core portion 11 with an increase in the number of turns. For example, when viewed in the first negative direction X2, the point of the first wire 41 traced 36 degrees around the central axis 11C from the point of 1.0 turn is referred to as the point of 1.1 turns of the first wire 41. FIG. 3 schematically illustrates the number of turns of each wire on the edges of the core portion 11 on its third positive direction Z1 side. FIG. 4 schematically illustrates the number of turns of each wire positioned on the central axis 11C of the core portion 11 when viewed in the second positive direction Y1.

As illustrated in FIG. 3, the first wire 41 is directly wound around the core portion 11 without the second wire 42 being interposed therebetween in all the turns. The phrase “a wire is directly wound around” herein includes, as well as a condition where the wire is in contact with the outer surface of the core portion 11, a condition where the wire is spaced from the core portion 11 and is wound around the core portion 11 without any wire being interposed therebetween.

The first turn of the first wire 41 corresponds to a section from the point of 1.0 turn of the first wire 41 to just before the point of 2.0 turns. The last turn of the first wire 41 refers to a turn including the portion that makes last contact with the outer surface of the core portion 11 when the first wire 41 is traced from the first wire end 41A to the second wire end 41B. In the embodiment, the last turn of the first wire 41 is the 21st turn.

As illustrated in FIG. 2, the first wire end 42A of the second wire 42 is coupled to the second outer electrode 32. The second wire end 42B of the second wire 42 is coupled to the fourth outer electrode 34. The first and second wire ends 42A and 42B are each coupled to the joining portion JP of the corresponding outer electrode 30 by thermocompression bonding.

Herein, when the second wire 42 is traced from the first wire end 42A to the second wire end 42B, the first point whose angular position about the central axis 11C coincides with the angular position of the point of 1.0 turn of the first wire 41 is defined as a point of 1.0 turn of the second wire 42. That is, in the embodiment, the point of 1.0 turn of the second wire 42 is positioned on a line connecting the central axis 11C and the edge of the core portion 11 on its second negative direction Y2 side and on its third positive direction Z1 side when viewed along the first axis X. In the embodiment, when the second wire 42 is traced from the first wire end 42A to the second wire end 42B, the point of 1.0 turn of the second wire 42 is in contact with a part of the outer surface of the first wire 41 opposite to the part facing the central axis 11C. The point of 1.0 turn of the second wire 42 may be in contact with the outer surface of the core portion 11.

As illustrated in FIGS. 3 and 4, the number of turns of the second wire 42 increases from the first wire end 42A to the second wire end 42B by one each time the second wire 42 turns once around the central axis 11C. When viewed in the first negative direction X2, the second wire 42 is wound clockwise around the core portion 11 with an increase in the number of turns. That is, the second wire 42 is wound around in the same direction as the first wire 41. A part of the second wire 42 is wound around the core portion 11 on the outside of the first wire 41. In other words, a part of the second wire 42 is in contact with a part of the outer surface of the first wire 41 opposite to the part facing the central axis 11C.

The last turn of the second wire 42 refers to a turn including the portion that makes last contact with the outer surface of the core portion 11 when the second wire 42 is traced from the first wire end 42A to the second wire end 42B. In the embodiment, the last turn of the second wire 42 is the 21st turn. In FIGS. 3 and 4, the part of each wire positioned on the first wire end side relative to the point of 1.0 turn is illustrated as the 0th turn.

### Winding of First Wire and Second Wire

As illustrated in FIG. 2, the second wire 42 includes a first winding portion 51 and a second winding portion 52.

As illustrated in FIG. 3, the first winding portion 51 is a portion including plural turns wound around the outer periphery of the first wire 41. In the embodiment, the first winding portion 51 is a part from the point of 1.0 turn of the second wire 42 to the middle of the 17th turn. That is, the first winding portion 51 is a part of the second wire 42 from the portion that runs on the outer side of the first wire 41 to the portion just before the second wire 42 is directly wound around the core portion 11.

As illustrated in FIGS. 3 and 4, the first to the eighth turns of the second wire 42 are directly wound around the outer periphery of the first wire 41. From the middle of the ninth turn of the second wire 42, the second wire 42 is directly wound around the outer periphery of the eighth and preceding turns of the second wire 42. That is, the second wire 42 runs on the outer periphery of the second layer of the second wire 42 in the middle of the ninth turn of the second wire 42. Specifically, the ninth turn of the second wire 42 runs on the outer periphery of the second layer of the second wire 42 on the face of the core portion 11 on its second positive direction Y1 side. The second half of the ninth turn of the second wire 42 is wound around between the sixth and the seventh turns of the second wire 42. The first winding portion 51 includes a portion TL, in which the second wire 42 is wound around the outer periphery of the first wire 41 in two or more layers.

As illustrated in FIG. 4, the ninth turn of the second wire 42 traverses the first wire 41 on the face of the core portion 11 on its second positive direction Y1 side. The phrase “a wire traverses the other wire” refers to when one of the wires runs across the other wire without running in the same layer as the other wire. Since such a traverse portion is provided, the second wire 42 includes points of contact with the X-th turn, the (X+1)-th turn, and the (X+2)-th turn of the first wire 41 in one turn (X is a positive integer). When the second wire 42 is traced from the first wire end 42A to the second wire end 42B, the second wire 42 runs across the first wire 41 in the traverse portion from the first negative direction X2 side to the first positive direction X1 side. Herein, the situation where a wire in the upper layer runs across a wire in a layer below is expressed as “a wire in the upper layer runs across a wire in the lower layer”. For example, the expression “the second wire 42 runs across the first wire 41” refers to when the second wire 42 in the upper layer runs across the first wire 41 wound in a layer below. In the embodiment, the first 0.5 turn of the ninth turn of the second wire 42 is positioned between the ninth and the 10th turns of the first wire 41. On the other hand, the second 0.5 turn of the ninth turn of the second wire 42 is positioned between the sixth and the seventh turns of the second wire 42. The ninth turn of the second wire 42 in the upper layer includes points of indirect contact with the seventh, the eighth, and the ninth turns of the first wire 41 with the second layer of the second wire 42 interposed therebetween. Herein, a groove formed between adjacent two turns of a wire is referred to as a valley. The ninth turn of the second wire 42 is laid across two valleys of the first wire 41 along the central axis 11C.

In a similar manner, the 10th turn of the second wire 42 is also directly wound around the outer surface of the second layer of the second wire 42. In the middle of the 11th turn of the second wire 42, the second wire 42 shifts from the outer periphery of the second layer of the second wire 42 to the outer periphery of the first wire 41. Specifically, the 11th turn of the second wire 42 shifts to the outer periphery of the first wire 41 on the face of the core portion 11 on its second positive direction Y1 side. The entirety of the 12th to 16th turns of the second wire 42 is directly wound around the outer periphery of the first wire 41.

As illustrated in FIG. 3, the 16th turn of the second wire 42 includes a traverse portion traversing the first wire 41. Specifically, the 16th turn of the second wire 42 includes points of contact with the 16th turn, 17th turn, and 18th turn of the first wire 41. Specifically, the traverse portion is positioned on the third positive direction Z1 side relative to the central axis 11C on the outer surface of the core portion 11. That is, the traverse portion is positioned in the second 0.5 turn of the 16th turn.

In the middle of the 17th turn, the second wire 42 shifts from the outer periphery of the first wire 41 to the outer surface of the core portion 11. Specifically, as illustrated in FIG. 4, the 17th turn of the second wire 42 shifts from the outer periphery of the first wire 41 to the outer surface of the core portion 11 on the face of the core portion 11 on its third negative direction Z2 side. That is, the second wire 42 shifts to the outer surface of the core portion 11 in a range from the point of 17.0 turns to the point of 17.5 turns.

When the second wire 42 is traced from the first wire end 42A toward the second wire end 42B in the first winding portion 51, the portion of the second wire 42 just before part of the second wire 42 directly wound around the outer surface of the core portion 11 is at the position closest to the second wire end 42B in the first winding portion 51. In other words, a portion of the second wire 42 positioned on the third negative direction Z2 side in the 17th turn is an end portion EP of the first winding portion 51.

In the embodiment, the traverse portion in the 16th turn of the second wire 42 is referred to as a first traverse portion 61. The first traverse portion 61 runs across the first wire 41 without running in the same layer as the first wire 41 in one turn immediately preceding the end portion EP. That is, the first winding portion 51 includes the first traverse portion 61.

As illustrated in FIG. 2, the first traverse portion 61 is positioned on the third positive direction Z1 side relative to the central axis 11C. Specifically, the first traverse portion 61 is positioned on the third positive direction Z1 side relative to the central axis 11C on the outer surface of the core portion 11. That is, the first traverse portion 61 is positioned on the same side as the joining portions JP of the outer electrodes 30 with respect to the central axis 11C. When the second wire 42 is traced from the first wire end 42A toward the second wire end 42B, in the first traverse portion 61, the second wire 42 runs across the first wire 41 from the first positive direction X1 side to the first negative direction X2 side along the central axis 11C.

As illustrated in FIG. 2, when viewed in the third negative direction Z2, the first winding portion 51 is positioned on the first flange portion 21 side relative to the center C of the core portion 11 along the central axis 11C. The first winding portion 51 is positioned off to the first positive direction X1 side on the core portion 11.

As illustrated in FIG. 3, the second winding portion 52 is positioned on the second wire 42's second wire end 42B side relative to the first winding portion 51. The second winding portion 52 is a winding portion of the second wire 42 at least a part of which is wound around the outer surface of the core portion 11 and which includes less than 1.0 turn continuously wound around the outer periphery of the first wire 41. Specifically, the second winding portion 52 is from the middle of the 17th turn of the second wire 42 to the last turn of the second wire 42. That is, the second winding portion 52 includes the last turn of the second wire 42.

As illustrated in FIGS. 3 and 4, the entirety of the 18th turn and 19th turn of the second wire 42 is directly wound around the outer surface of the core portion 11. The 18th turn of the second wire 42 is positioned on the first negative direction X2 side relative to the 18th turn of the first wire 41. Part of the outer surface of the 18th turn of the second wire 42 on its first positive direction X1 side is in contact with part of the outer surface of the 18th turn of the first wire 41 on its first negative direction X2 side. On the other hand, the 17th turn of the second wire 42 is separated from the 18th turn of the first wire 41 along the central axis 11C.

The 19th turn of the first wire 41 is positioned on the first negative direction X2 side relative to the 18th turn of the second wire 42. The 19th turn of the second wire 42 is positioned on the first negative direction X2 side relative to the 19th turn of the first wire 41. Part of the outer surface of the 19th turn of the second wire 42 on its first positive direction X1 side is in contact with part of the outer surface of the 19th turn of the first wire 41 on its first negative direction X2 side. On the other hand, the 18th turn of the second wire 42 is separated from the 19th turn of the first wire 41 along the central axis 11C. That is, the second winding portion 52 includes portions PA, each of which is arranged away from an adjacent wire on at least one side along the central axis 11C. The portions PA, each of which is arranged away from an adjacent wire along the central axis 11C, expose the outer surface of the core portion 11.

The second winding portion 52 includes a first intersection portion 62, which intersects the first wire 41. Specifically, the turn of the second wire 42 immediately preceding its last turn and the turn of the first wire 41 immediately preceding its last turn include the first intersection portion 62, in which the turns of the second wires 42 and 41 immediately preceding the respective last turns intersect. That is, in the embodiment, the 20th turn of the second wire 42 includes the first intersection portion 62. The phrase “wires intersect” refers to that when one of the wires is traced from its first wire end to its second wire end, the wire in the same layer as the other wire once runs on the outer side of the other wire and then returns to the same layer as the other wire. In the embodiment, as illustrated in FIG. 2, the term “intersection portion” refers to a portion in which the centerline of the second wire 42 intersects the centerline of the first wire 41 when viewed in a direction perpendicular to the central axis 11C of the core portion 11. The above explanation “the centerline of the second wire 42 intersects the centerline of the first wire 41” has the same meaning as “the centerline of the first wire 41 intersects the centerline of the second wire 42”.

As illustrated in FIG. 2, in the embodiment, the first intersection portion 62 is positioned on the third positive direction Z1 side relative to the central axis 11C. Specifically, the first intersection portion 62 is positioned on the third positive direction Z1 side relative to the central axis 11C on the outer surface of the core portion 11. That is, the first intersection portion 62 is positioned on the same side as the joining portions JP of the outer electrodes 30 with respect to the central axis 11C. When the second wire 42 is traced from the first wire end 42A toward the second wire end 42B, in the first intersection portion 62, the second wire 42 runs across the first wire 41 from the first negative direction X2 side to the first positive direction X1 along the central axis 11C. That is, when the second wire 42 is traced from the first wire end 42A toward the second wire end 42B, the direction along the central axis 11C in which the second wire 42 runs across the first wire 41 in the first traverse portion 61 is opposite to the direction along the central axis 11C in which the second wire 42 runs across the first wire 41 in the first intersection portion 62.

In the embodiment, the second winding portion 52 does not include any intersection portion other than the first intersection portion 62. Part of the second winding portion 52 other than the first intersection portion 62 is directly wound around the outer surface of the core portion 11. In other words, the second winding portion 52 only runs on the first wire 41 in the vicinity of the first intersection portion 62. The second winding portion 52 includes less than 1.0 turn continuously wound around the outer periphery of the first wire 41.

As illustrated in FIG. 2, when the second wire 42 is traced from the first wire end 42A to the second wire end 42B, a portion TP, which makes last contact with the outer surface of the core portion 11, is a portion in the 21th turn, which is in contact with the edge of the core portion 11 on the third positive direction Z1 side and on the second positive direction Y1 side. When the core portion 11 is divided into three equal regions along the central axis 11C, the portion TP is positioned in a region AP, which is the closest to the second flange portion 22 among the three equal regions.

The point of 1.0 turn of the first wire 41 is positioned on the first positive direction X1 side relative to the point of 1.0 turn of the second wire 42. As illustrated in FIG. 4, therefore, the second wire 42 intersects the first wire 41 in the vicinity of the point of 1.0 turn of the second wire 42 when the coil component 10 is viewed in the second positive direction Y1. In this intersection portion in the vicinity of the point of 1.0 turn, the second wire 42 runs across the first wire 41 from the first positive direction X1 side to the first negative direction X2 side when the second wire 42 is traced from the first wire end 42A to the second wire end 42B.

Thus, the second wire 42 runs across the first wire 41 in the four portions including the intersection portion in the vicinity of 1.0 turn, the traverse portion in the ninth turn of the second wire 42, the first traverse portion 61, and the first intersection portion 62. In two of these four portions, the second wire 42 runs across the first wire 41 from the first positive direction X1 side to the first negative direction X2 side when the second wire 42 is traced from the first wire end 42A to the second wire end 42B. In the other two portions, the second wire 42 runs across the first wire 41 in the direction opposite thereto.

### Mode Conversion Characteristics

Ssd12 was measured for the coil component 10 of the embodiment, a coil component of Comparative Example 1, and a coil component of Comparative Example 2 as an indicator of mode conversion characteristics. The dimensions of the coil components of Comparative Examples 1 and 2 were the same as those of the coil component 10 of the embodiment. The materials of the drum core and the top plate of the coil components of Comparative Examples 1 and 2 were the same as those of the coil component 10 of the embodiment. The number of turns of each wire of the coil components of Comparative Examples 1 and 2 was 21, which was the same as those of the coil component 10 of the embodiment. In the coil component of Comparative Example 1, the intersection portion closest to the second wire ends was positioned on part of the surface of the core portion 11 that faces the second negative direction Y2, not on the same side as the joining portions JP of the outer electrodes 30 with respect to the central axis 11C. Specifically, the intersection portion in the coil component of Comparative Example 1 was in the 21th turns of the first and second wires. In the coil component of Comparative Example 2, the intersection portion closest to the second wire ends was positioned on part of the outer surface of the core portion 11 that faces the third negative direction Z2, not on the same side as the joining portions JP of the outer electrodes 30 with respect to the central axis 11C. Specifically, the intersection portion in the coil component of Comparative Example 2 was in the 21th turns of the first and second wires. 20 pieces were created for each coil component. That is, the number of prototypes of each coil component was 20.

In the measurement, the coil component 10 of the embodiment, the coil component of the comparative example 1, and the coil component of the comparative example 2 were each mounted on an Open Alliance-compliant 3 port substrate. After SOLT calibration, Ssd12 of each coil component was measured. The measurement result acquired from each coil component, that is, the average value of the 20 measurement results was used as a representative value of the measurement result.

Ssd12 of the coil component 10 of the embodiment was −77.5 dB when the measurement frequency was 500 kHz. Ssd12 of the coil component of Comparative Example 1 was −75.0 dB when the measurement frequency was 500 kHz. Ssd12 of the coil component of Comparative Example 2 was −76.2 dB when the measurement frequency was 500 kHz. This revealed that the Ssd 12 value could be reduced when the first traverse portion 61 was positioned on the third positive direction Z1 side. In other words, it was revealed that the Ssd12 value could be reduced when the first traverse portion 61 is positioned on the same side as the joining portions JP of the outer electrodes 30 more than when the first traverse portion 61 is positioned on a different side from the joining portions JP of the outer electrodes 30.

### Effect of Embodiment

(1) According to the aforementioned embodiment, in the portion where the first winding portion 51 of the second wire 42 is provided, the first wire 41 and the second wire 42 constitute a two or more-layer structure. On the other hand, the second winding portion 52 of the second wire 42 is not wound around the outer periphery of the first wire 41 and has a one-layer structure. The wire layer structure on the core portion 11 is asymmetric between the first flange portion 21 side and the second flange portion 22 side. With this asymmetric structure, the orientation of the coil component 10 can be easily distinguished through observation of its exterior.

In the aforementioned configuration, the first winding portion 51 includes the first traverse portion 61. The positional relationship between the first wire 41 and the second wire 42 along the central axis 11C is reversed between the turns before and after the first traverse portion 61. The provision of such an intersection portion in the first winding portion 51 can reduce by one, the number of intersection portions required to be provided for the second winding portion 52 for eliminating twisting of the two wires. The reduction in the number of intersection portions in which the second wire 42 intersects the first wire 41 in the second winding portion 52 will result in a decrease in the number of portions in which the second wire 42 runs on the first wire 41 in the second winding portion 52. That is, the area on the core portion 11 where only the second wire 42 is continuously wound around in a one-layer structure can be increased. This makes it easier to distinguish whether the wires have a two or more-layer structure or a one-layer structure.

(2) In the aforementioned embodiment, the first winding portion 51 is positioned on the first flange portion 21 side relative to the center C of the core portion 11 along the central axis 11C. By clearly separating the part including the first winding portion 51 from the part including the second winding portion 52 at the center C of the core portion 11 as a boundary in such a manner, the orientation of the coil component 10 can be easily distinguished with an inspection apparatus or the like.

(3) In the aforementioned embodiment, the first winding portion 51 includes the portion TL, in which the second wire 42 is wound around the outer periphery of the first wire 41 in two or more layers. That is, the coil component 10 includes a part in which the coil is wound around in three layers in total. The exterior of the part including the first winding portion 51 can therefore be more distinct from the exterior of the part including the second winding portion 52.

(4) In the aforementioned embodiment, the second winding portion 52 includes the last turn of the second wire 42. The turn of the second wire 42 immediately preceding its last turn and the turn of the first wire 41 preceding its last turn include the first intersection portion 62, in which the turn of the second wire 42 immediately preceding its last turn and the turn of the first wire 41 preceding its last turn intersect. Between the first intersection portion 62 and the second wire end 42B along the central axis 11C, part of the second wire 42 drawn out toward the fourth outer electrode 34 and the last turn of the second wire 42 are interposed. This means that the first intersection portion 62 is distant from the second wire end 42B. It is therefore possible to reduce the total amount of heat concentrated to the first intersection portion 62 due to thermocompression bonding of the second wire end 42B of the second wire 42 in the manufacturing process.

(5) In the aforementioned embodiment, the first intersection portion 62 is positioned on the third positive direction Z1 side relative to the central axis 11C. In other words, the first intersection portion 62 is positioned on the same side as the joining portions JP of the outer electrodes 30. This configuration reduces asymmetry in electric characteristics, including inductance and capacitance, as revealed in the measurement results of Ssd12, thus improving the mode conversion characteristics as revealed in the measurement results of Ssd12. That is, according to this configuration, Ssd12 is improved compared to the coil component in which the first intersection portion 62 is provided on the core portion 11, other than on the third positive direction Z1 side.

(6) In the embodiment, the direction along the central axis 11C in which the second wire 42 runs across the first wire 41 in the first traverse portion 61 is opposite to the direction along the central axis 11C in which the second wire 42 runs across the first wire 41 in the first intersection portion 62. In portions where the second wire 42 runs across the first wire 41, the first wire 41 is wound around while being pressed by the second wire 42. The first wire 41 is therefore subjected to external force in the direction in which the second wire 42 runs across the first wire 41. Since the direction in which the second wire 42 runs across the first wire 41 in the first traverse portion 61 is different from that in the first intersection portion 62, external forces acting on the first wire 41 in the first traverse portion 61 and in the first intersection portion 62 cancel out each other. The aforementioned configuration can prevent the first wire 41 from moving and thereby stabilize the winding of the second wire 42.

(7) In the aforementioned embodiment, the second winding portion 52 includes the portions PA, each of which is arranged away from an adjacent wire along the central axis 11C. As described above, the portions PA, each of which is arranged away from an adjacent wire, expose the core portion 11. Since the material of each wire is different from that of the core portion 11, the wires and the core portion 11 have different optical characteristics. The orientation of the coil component 10 can be distinguished through optical observation of the core portion 11 in the section where the second winding portion 52 is positioned.

(8) In the aforementioned embodiment, the portion TP, which makes last contact with the outer surface of the core portion 11 when the second wire 42 is traced from the first wire end 42A to the second wire end 42B, is positioned in the region AP, which is the closest to the second flange portion 22 among the aforementioned three regions. That is, the last turn of the second wire 42 is positioned close to the second flange portion 22. According to this configuration, part of the second wire 42 from the portion TP, which makes last contact with the outer surface of the core portion 11, to the point coupled to the fourth outer electrode 34 can be prevented from being extremely long. This can prevent another member from catching on the part of the second wire 42 from the portion TP, which makes last contact with the outer surface of the core portion 11, to the point coupled to the fourth outer electrode 34, thus reducing disconnection of the second wire 42.

(9) In the aforementioned embodiment, the ninth turn of the second wire 42 includes a traverse portion that traverses the first wire 41. This configuration can balance stray capacitance between part around that traverse portion and part around the first traverse portion 61, thus improving the electric characteristics.

### MODIFICATION

The aforementioned embodiments and the following modifications can be carried out in combination within a technically consistent range.

### Modification for Coil Component

The top plate 10F of the coil component 10 may be omitted in the aforementioned embodiments. The dimensions of the coil components 10 are not limited to the examples of the aforementioned embodiments.

The shape of the core portion 11 is not limited to the examples of the aforementioned embodiments. For example, the core portion 11 may have a cylindrical shape or a polygonal prism shape other than the rectangular prism shape.

The configuration of the drum core 10C is not limited to the examples of the aforementioned embodiments. For example, the first flange portion 21 and the second flange portion 22 do not need to protrude in the third positive direction Z1 at the center along the second axis Y. For example, the first and second flange portions 21 and 22 may have a fork-like shape recessed at the center along the second axis Y.

The method of coupling the joining portions JP of the outer electrodes 30 to ends of wires is not limited to thermocompression bonding. For example, ends of wires may be joined to the joining portions JP with a laser or may be joined thereto by another method.

The material and shape of the outer electrodes 30 are not limited to the examples of the aforementioned embodiments although the outer electrodes 30 need to be able to be coupled to the first and second wires 41 and 42. For example, each outer electrode 30 may include a metal layer and a plating layer, and the wires may be coupled to the plating layer.

### Modification for Wire

The numbers of turns of the first wire 41 and the second wire 42 are not limited to

21. The number of turns of the first winding portion 51 and the number of turns of the second winding portion 52 are also not limited to the examples of the aforementioned embodiment.

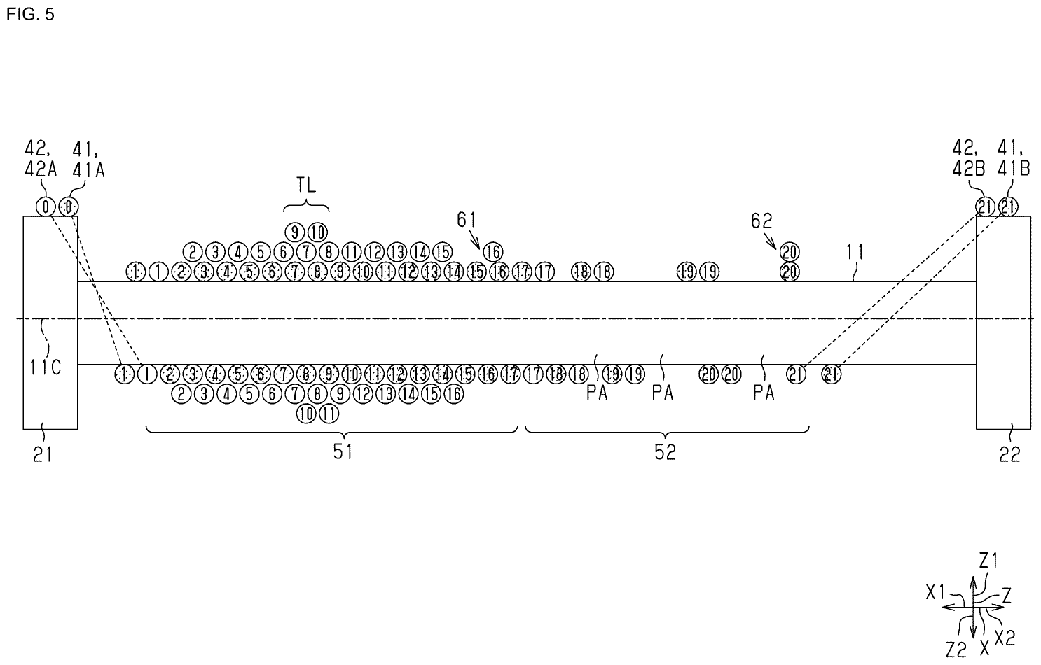

For example, in the example illustrated in FIG. 5, the second wire 42, at the position of 1.0 turn, is directly wound around the outer surface of the core portion 11 without the first wire 41 being interposed therebetween. Specifically, the first turn of the second wire 42 is positioned on the first negative direction X2 side relative to the first turn of the first wire 41. The second wire 42 is wound around the outer periphery of the first wire 41 from the second turn to the 15th turn.

In the example illustrated in FIG. 5, the second wire 42 shifts from the outer periphery of the first wire 41 to the outer surface of the core portion 11 in the middle of the 16th turn. The point of 17.0 turns of the second wire 42 is positioned on the outer surface of the core portion 11. In the example illustrated in FIG. 5, the end portion EP of the first winding portion 51 is positioned before the point of 17.0 turns. That is, in the example illustrated in FIG. 5, the first winding portion 51 is from the second turn to the 16th turn. In the example illustrated in FIG. 5, like the aforementioned embodiment, the 16th turn of the second wire 42 traverses the first wire 41. That is, also in the example illustrated in FIG. 5, the first winding portion 51 includes the first traverse portion 61, which runs across the first wire 41 without running in the same layer as the first wire 41, in one turn immediately preceding the end portion EP.

In the example illustrated in FIG. 5, the second turn of the second wire 42, as well as the first turn of the first wire 41, exists on the outer surface of the core portion 11 in or before the second turn of the first wire 41. The first turns of the two wires are able to limit movement of the second and subsequent turns of the first wire 41 in the first positive direction X1. This can reduce disorderly winding of the second and subsequent turns of the first and second wires 41 and 42.

The first intersection portion 62 may be omitted from the second wire 42. For example, the first intersection portion 62 may be properly employed depending on the numbers and directions of intersections and traverses provided in part of each wire drawn out from the core portion 11 to the corresponding outer electrode 30.

The direction along the central axis 11C in which the second wire 42 runs across the first wire 41 in the first traverse portion 61 may be the same as the direction along the central axis 11C in which the second wire 42 runs across the first wire 41 in the first intersection portion 62. This direction, in which the second wire 42 runs across the first wire 41, may be properly changed depending on whether the second wire 42 runs across the first wire 41 in another portion, the direction in which the second wire 42 runs across the first wire 41 in another portion, and the like.

The second wire 42 does not need to intersect the first wire 41 in the vicinity of 1.0 turn of the second wire 42 when the coil component 10 is viewed in the second positive direction Y1. When the second wire 42 includes plural pairs of intersection portions where the second wire 42 runs across the first wire 41 in different directions, twisting of wires can be eliminated as a whole.

The second wire 42 may further include an intersection portion in a place other than the first intersection portion 62 of the aforementioned embodiment. The second wire 42 may further include a traverse portion in a place other than the first traverse portion 61 of the aforementioned embodiment.

The positions of the first intersection portion 62 along the central axis 11C, along the second axis Y, and along the third axis Z are not limited to the examples of the aforementioned embodiment. That is, the first intersection portion 62 may be positioned on the outer surface of the core portion 11 other than its face facing the third positive direction Z1. As a result, the first intersection portion 62 may be positioned on the outer surface of the core portion 11 in a direction different from the direction of the outer electrodes 30 in each flange portion. This applies to the first traverse portion 61.

The first winding portion 51 does not need to be positioned on the first flange portion 21 side relative to the center C of the core portion 11 along the central axis 11C. That is, the first winding portion 51 may extend to the second flange portion 22 side relative to the center C of the core portion 11 along the central axis 11C.

The first winding portion 51 does not need to include the portion TL, in which the second wire 42 is wound around the outer periphery of the first wire 41 in two or more layers. That is, the first winding portion 51 does not need to include the third layer.

The second winding portion 52 does not include the portions PA, each of which is separated from an adjacent wire along the central axis 11C.

The portion TP, which makes last contact with the outer surface of the core portion 11 when the second wire 42 is traced from the first wire end 42A to the second wire end 42B, is not limited to being in the region AP, which is the closest to the second flange portion 22 among the three regions. That is, the portion TP, which makes last contact with the outer surface of the core portion 11, may be positioned in the other two regions.

In the first intersection portion 62, the first wire 41 may run over the outer side of the second wire 42. That is, the turn of the first wire 41 preceding its last turn and the turn of the second wire 42 preceding its last turn need to intersect each other, but either one can be positioned on the outer side in the first intersection portion 62.

### Note

The technical ideas derived from the aforementioned embodiment and modifications will be described below.

[1] A coil component including: a drum core including: a columnar core portion; a first flange portion coupled to a first end of the core portion in a direction along a central axis; and a second flange portion coupled to a second end of the core portion on a side opposite to the first end; a first outer electrode and a second outer electrode that are positioned on a surface of the first flange portion; a third outer electrode and a fourth outer electrode that are positioned on a surface of the second flange portion; a first wire that is wound around the core portion and has a first wire end coupled to the first outer electrode and a second wire end coupled to the third outer electrode; and a second wire that is wound around the core portion in the same direction as the first wire and has a first wire end coupled to the second outer electrode and a second wire end coupled to the fourth outer electrode. The number of turns of the first wire increases by one from the first wire end toward the second wire end each time the first wire turns once around the central axis. Also, the number of turns of the second wire increases by one from the first wire end toward the second wire end each time the second wire turns once around the central axis. The second wire includes a first winding portion including a plurality of turns wound around an outer periphery of the first wire; and a second winding portion which is positioned on a second wire end side relative to the first winding portion, at least a part of which is wound around an outer surface of the core portion, and which includes less than 1.0 turn continuously wound around the outer periphery of the first wire. Also, the first winding portion includes a first traverse portion that runs across the first wire without running in the same layer as the first wire in one turn immediately preceding an end portion of the first winding portion, where the end portion of the first winding portion refers to a portion of the second wire closest to the second wire end in the first winding portion when the second wire is traced from the first wire end toward the second wire end in the first winding portion.

[2] The coil component according to [1], in which the first winding portion is positioned on a first flange portion side relative to a center of the core portion in a direction along the central axis.

[3] The coil component according to [1] or [2], in which the first winding portion includes a part of the second wire wound around the outer periphery of the first wire in two or more layers.

[4] The coil component according to any one of [1] to [3], in which where last turns refer to turns of the first and second wires including portions that make last contact with the outer surface of the core portion when the first and second wires are traced from the first wire ends toward the second wire ends, the second winding portion includes the last turn of the second wire, and a turn of the first wire immediately preceding the last turn thereof and a turn of the second wire immediately preceding the last turn thereof include a first intersection portion at which the turns of the first and second wires immediately preceding the respective last turns thereof intersect.

[5] The coil component according to [4], in which where a particular direction perpendicular to the central axis is referred to as a positive direction, the first outer electrode and the second outer electrode are positioned on a positive direction side relative to the central axis on a surface of the first flange portion, the third outer electrode and the fourth outer electrode are positioned on the positive direction side relative to the central axis on a surface of the second flange portion, and the first intersection portion is positioned on the positive direction side relative to the central axis on the outer surface of the core portion.

[6] The coil component according to [4] or [5], in which when the second wire is traced from the first wire end to the second wire end, the direction along the central axis in which the second wire runs across the first wire in the first traverse portion is opposite to the direction along the central axis in which the second wire runs across the first wire in the first intersection portion.

[7] The coil component according to any one of [1] to [6], in which the second winding portion includes a portion arranged away from an adjacent wire on at least one side in the direction along the central axis.

[8] The coil component according to any one of [1] to [7], in which a portion of the second wire that makes last contact with the outer surface of the core portion when the second wire is traced from the first wire end to the second wire end is positioned in a region that is the closest to the second flange portion among three equal regions obtained by dividing the core portion in the direction along the central axis.

What is claimed is:

1. A coil component comprising:
a drum core including:
a columnar core portion;
a first flange portion coupled to a first end of the core portion in a direction along a central axis; and
a second flange portion coupled to a second end of the core portion on a side opposite to the first end;
a first outer electrode and a second outer electrode that are on a surface of the first flange portion;
a third outer electrode and a fourth outer electrode that are on a surface of the second flange portion;
a first wire that is wound around the core portion and has a first wire end connected to the first outer electrode and a second wire end connected to the third outer electrode; and
a second wire that is wound around the core portion in the same direction as the first wire and has a first wire end connected to the second outer electrode and a second wire end connected to the fourth outer electrode,
wherein
a number of turns of the first wire increases by one turn each time the first wire turns once around the central axis from the first wire end toward the second wire end,
a number of turns of the second wire increases by one turn each time the second wire turns once around the central axis from the first wire end toward the second wire end,
the second wire includes:
a first winding portion including a plurality of turns of the second wire wound around an outer periphery of the first wire; and
a second winding portion which is on a second wire end side with respect to the first winding portion, the second winding portion including at least a portion of the second wire being wound around an outer surface of the core portion, and at least a portion of the second wire including less than 1.0 turn continuously wound around the outer periphery of the first wire, and
where an end portion of the first winding portion defines an end portion of the second wire closest to the second wire end side in the first winding portion when the second wire is traced from the first wire end toward the second wire end in the first winding portion,
the first winding portion includes a first traverse portion in which the second wire straddles the first wire without arriving at the same layer as the first wire in a section from the end portion of the first winding portion to one turn preceding.

2. The coil component according to claim 1, wherein
the first winding portion is on a first flange portion side with respect to a center of the core portion in a direction along the central axis.

3. The coil component according to claim 1, wherein
the first winding portion includes a part of the second wire wound around the outer periphery of the first wire in two or more layers.

4. The coil component according to claim 1, wherein
when the first wire and the second wire are traced from the first wire ends toward the second wire ends, last turns of the first and the second wires defines turns of the first wire and the second wire including portions that make last contact with the outer surface of the core portion,
the second winding portion includes the last turn of the second wire, and
a turn of the first wire immediately preceding the last turn thereof and a turn of the second wire immediately preceding the last turn thereof intersect at a first intersection portion in the second winding portion.

5. The coil component according to claim 4, wherein
where a specific direction orthogonal to the central axis is defined as a positive direction,
the first outer electrode and the second outer electrode are on a surface of the first flange portion in the positive direction side with respect to the central axis,
the third outer electrode and the fourth outer electrode are on a surface of the second flange portion in the positive direction side with respect to the central axis, and
the first intersection portion is on the outer surface of the core portion in the positive direction side with respect to the central axis.

6. The coil component according to claim 4, wherein
when the second wire is traced from the first wire end to the second wire end, the direction along the central axis in which the second wire straddles the first wire in the first traverse portion is opposite to the direction along the central axis in which the second wire straddles the first wire in the first intersection portion.

7. The coil component according to claim 1, wherein
the second winding portion includes a space where adjacent wires are arranged spaced away from each other on at least one side in the direction along the central axis.

8. The coil component according to claim 1, wherein
when dividing the core portion into three equal regions in the direction along the central axis, and when the second wire is traced from the first wire end to the second wire end, a portion of the second wire that makes last contact with the outer surface of the core portion is in a region that is the closest to the second flange portion among the three regions.
